(19) United States
(12) Patent Application Publication
(10) Pub. No.: US 2006/0098748 A1
(43) Pub. Date: May 11, 2006

(54) MULTI-CARRIER COMMUNICATION SYSTEM AND COMMUNICATION METHOD THEREOF

(76) Inventors: Heng-Cheng Yeh, Taipei City (TW); Po-Yuan Wang, Chang-Hua Hsien (TW); Chia-Liang Lin, Union City, CA (US); Cheng-Hsian Li, Tainan Hsien (TW); Pei-Chieh Hsiao, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/164,069

(22) Filed: Nov. 9, 2005

Related U.S. Application Data
(60) Provisional application No. 60/522,799, filed on Nov. 9, 2004.

(30) Foreign Application Priority Data
Apr. 18, 2005 (TW) 094112254

(51) Int. Cl. H04K 1/10

(52) U.S. Cl. 375/260

(57) ABSTRACT

A multi-carrier communication system is disclosed. The multi-carrier communication system includes a transmitting module for generating a first time-domain signal by performing an inversed Fourier transform upon a transmitting data; a receiving module for receiving a second time-domain signal and for generating a decoded data by performing a Fourier transform upon the second time-domain signal; and an echo cancellation unit, coupled to the transmitting module and the receiving module, for generating a reconstructed data according to a plurality of computing coefficients, the decoded data, and the transmit data, and for adjusting the computing coefficients according to the reconstructed data.

### CROSS REFERENCE TO RELATED APPLICATIONS

This application claims the benefit of U.S. Application No. 60/522,799 filed Nov. 9, 2004 and included herein by reference.

### BACKGROUND OF THE INVENTION

1. Field of the Invention

The invention relates to communication systems, and more particularly to multi-carrier communication systems.

2. Description of the Prior Art

Generally, communication systems can be classified into one of the following: simplex systems, half-duplex systems, or full-duplex systems. Since the half-duplex systems and the full-duplex systems are capable of dual-directional transmission, i.e., transmitting and receiving data, it is inevitable that the downloaded (i.e., received) data will be interfered by the uploaded (i.e., transmitted) data. Take the Discrete Multi-Tone (DMT) system as an example. The DMT system modulates a transmit data D onto a plurality of sub-carriers by executing an inversed Fourier transform upon the transmit data D, and then the DMT system transmits the modulated result time-domain signal S1 to a transmitting medium, such as a cable, or radio frequency through air. When the DMT system receives a data, the DMT system further executes a Fourier transform upon a received time-domain signal S2 to generate a decoded data D′. However, if the analog front-end hybrid circuit is impedance-mismatched, the time-domain signal SI might interfere with the time-domain signal S2. The interference between these two time domain signals S1 and S2 is the so-called echo phenomenon and is well known in the art.

Please refer to FIG. 1. FIG. 1 is a schematic diagram of a DMT system 10. As shown in FIG. 1, the inversed Fourier transform unit 22 of the DMT system 10 is utilized to execute an inversed Fourier transform upon the transmit data D to generate a time-domain signal S1, and then the inversed Fourier transform unit 22 outputs the time-domain signal S1 to the filter 26. After the time-domain signal S1 enters the filter 26, the filtered time-domain signal S1 is transmitted to an analog front end (AFE) 28. Finally, the analog front end 28 outputs the time-domain signal S1 to the transmitting medium (not shown). Additionally, through utilizing the analog front end 28, the DMT system 10 is also capable of receiving a time-domain signal S2 from the transmitting medium. The analog front end 28 passes the time-domain signal S2 to the filter 36. For alleviating the interference caused by the time-domain signal S1 to the time-domain signal S2 (i.e., the echo of the time-domain signal S1), the DMT system 10 comprises an echo estimating unit 24 for generating an echo estimation signal Secho corresponding to the time-domain signal S1. An adjusting unit 34 generates a timing signal S2′ by subtracting the echo estimation signal Secho from the time-domain signal S2. Then, the Fourier transform unit 32 executes a Fourier transform upon the timing signal S2′ to generate a decoded data D′. Therefore, the decoded data D′ is free of interference by the echo phenomenon.

Although the DMT system 10 mentioned above can effectively alleviate the echo phenomenon, due to a much higher sampling rate of the time domain signals S1 and S2, in the process of calculating the echo estimation signal S_{echo} considerable computational resources will be consumed.

### SUMMARY OF THE INVENTION

It is therefore an objective of the present invention to provide a multi-carrier communication system capable of alleviating echo phenomenon while occupying lesser computational resources.

According to an embodiment, a multi-carrier communication system is disclosed. The multi-carrier communication system comprises: a transmitting module, for executing an inversed Fourier transform upon a transmit data to generate a first time-domain signal; a receiving module, for receiving a second time-domain signal and for executing a Fourier transform upon the second time-domain signal to generate a decoded data; and an echo cancellation unit, coupled to the transmitting module and the receiving module, for generating a reconstructed data according to a plurality of computing coefficients, the decoded data, and the transmit data, and for adjusting the plurality of computing coefficients according to the reconstructed data.

According to an embodiment, a method for eliminating the echo among a multi-carrier communication system is disclosed. The method comprises: executing an inversed Fourier transform upon a transmit data to generate a first time-domain signal; transmitting the first time-domain signal; receiving a second time-domain signal; generating a decoded data by executing a Fourier transform upon the second time-domain signal; generating a reconstructed data according to a plurality of computing coefficients, the decoded data, and the transmit data; and adjusting the plurality of computing coefficients according to the reconstructed data.

According to an embodiment, a multi-carrier communication apparatus for transmitting and receiving data in a multi-carrier communication system is disclosed. The multi-carrier communication apparatus comprises: a frequency-domain to time-domain converting module, for converting a first frequency-domain signal to be transmitted into a first time-domain signal; a time-domain to frequency-domain converting module, for converting a second time-domain signal received into a second frequency-domain signal; and an echo cancellation module, coupled to the frequency-domain to time-domain converting module and the time-domain to frequency-domain converting module, for adjusting the second frequency-domain signal according to the first frequency-domain signal thereby alleviating the echo received by the multi-carrier communication apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a discrete multi-tone system.

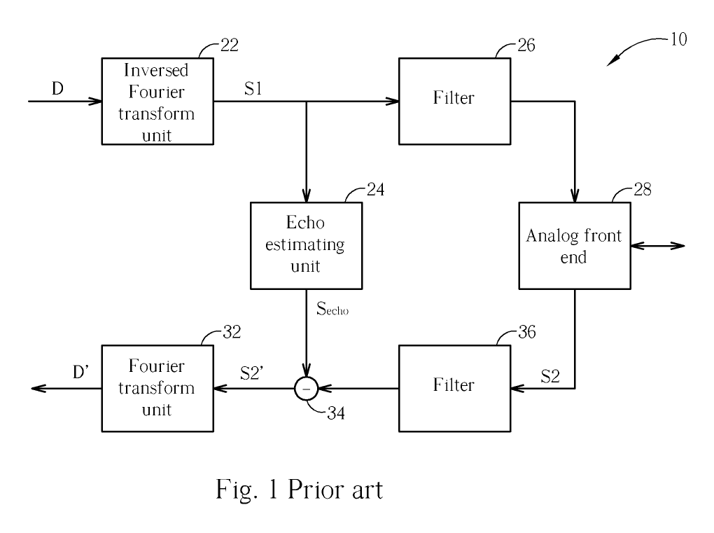

FIG. 2 is a schematic diagram of a multi-carrier communication system according to an embodiment of the present invention.

FIG. 3 is a schematic diagram of the echo estimating unit shown in FIG. 2 according to an embodiment of the invention.

FIG. 4 is a schematic diagram of a computing unit shown in FIG. 3 according to one embodiment of the invention.

FIG. 5 is a schematic diagram of a computing unit shown in FIG. 3 according to another embodiment of the invention.

### DETAILED DESCRIPTION

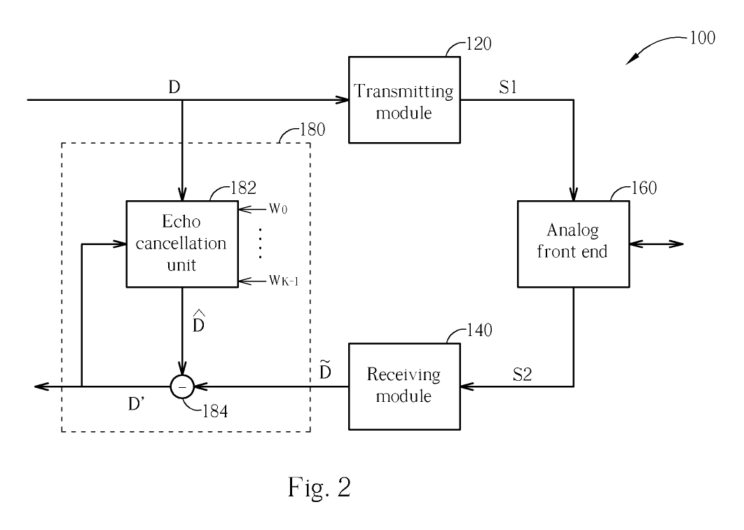

Please refer to FIG. 2. FIG. 2 is a schematic diagram of a multi-carrier communication system 100 according to a preferred embodiment. In the present embodiment, the multi-carrier communication system 100 is a discrete multi-tone (DMT) system or an orthogonal frequency division multiplexing (OFDM) system. However, according to the present invention, the multi-carrier communication system 100 is not limited to a DMT system or an OFDM system. In the present embodiment, the multi-carrier communication system 1I0 includes a transmitting module 120, a receiving module 140, an analog front end 160, and an echo cancellation unit 180. As is well known in the art, the transmitting module 120 executes an inversed Fourier transform upon a transmit data D to generate a time-domain signal S1, and the receiving module 140 receives a time-domain signal S2 and then executes a Fourier transform upon the time-domain signal S2 to generate a decoded data \tilde{D}. The analog front end 160 is coup led to a transimittiing med iu ms such as a twisted-pair cable, for transmitting the time-domain signal S1 or receiving tihe time-domain signal 52. The echo cancellation unit 180 is utilized to generate a reconstructed data D′ according to a plurality of computing coefficients w₀˜wₖ₋₁ the transmit data D, and the decoded data \tilde{D}, wherein k represents the total number of sub-carriers used by the multi-carrier communication system 100. As a result, the reconstructed data D′ can more accurately reflect the data content carried in the decoded data \tilde{D}, at the same time free of the interference of the echo of the transmit data D. Although the number of the computing coefficients are the same as the number of the sub-carriers of the multi-carrier communication system 100 according to the present embodiment, the present invention is not limited thereto, anid generating the reconstructed data D′ through utilizing fewer computing coefficients and simpler computation processes also falls within the scope of the present invention.

Typically, the transmitting module 120 comprises hardware and/or software to implement functions such as inverse Fourier transform, appending cyclic-prefix, parallel to serial conversion, digital to analog conversion, and signal filtering, or at least some of the functions mentioned above. Similarly, the receiving module 140 comprises hardware and/or software to implement functions such as filtering, analog to digital conversion, serial to parallel conversion, removing cyclic-prefix, and Fourier transform, or at least some of the functions mentioned above. Since the operations of the transmitting module 120, the receiving module 140, and the analog front end 160 are all well known by people skilled in the art, detailed descriptions related to these items are herein omitted.

The echo cancellation unit 180 further comprises an echo estimating unit 182 and an adjusting unit 184. The echo estimating unit 182 generates an echo estimation signal \hat{D} by processing the transmit data D and the plurality of computing coefficients w₀, . . . , wₖ₋₁. The adjusting unit 184 subtracts the echo estimation signal \hat{D} from the decoded data \tilde{D} to generate the reconstructed data D′. It should be noted that the adjusting unit 184 is a subtractor utilized to adjust the decoded data \tilde{D} according to the present embodiment. In addition, the echo estimating unit 182 performs a Least Mean Square (LMS) operation on the reconstructed data D′ to adjust the computing coefficients w₀, . . . , wₖ₋₁, and then the echo estimating unit 182 utilizes the adjusted computing coefficients w₀, . . . , wₖ₋₁ and the transmit data D to generate the desired echo estimation signal \hat{D}. The detail description of adjusting the computing coefficients w₀, . . . , wₖ₋₁ according to the LMS algorithm will be detailed in the following paragraphs. Please note that other adaptive signal processing algorithms, such as RLS algorithm and Signed LMS algorithm, can also be adopted to adjust the computing coefficients w₀, . . . , wₖ₋₁ in the present invention.

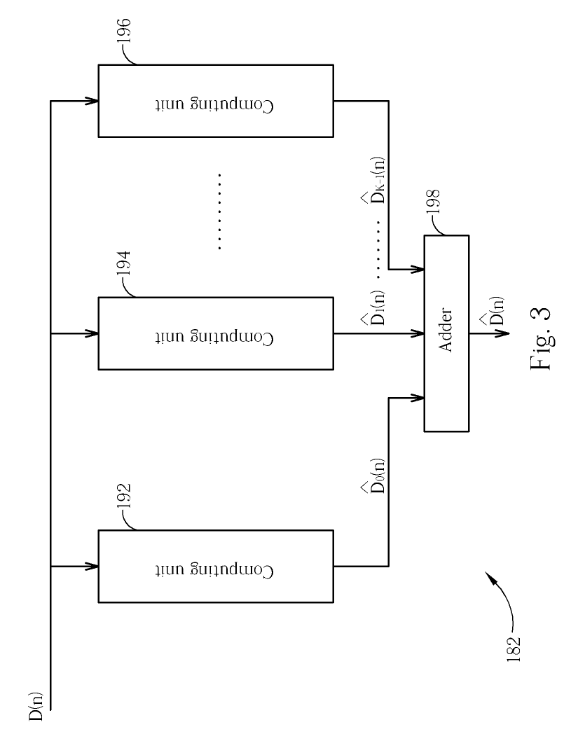

Please refer to FIG. 3. FIG. 3 is a schematic diagram of the echo estimating unit 182 shown in FIG. 2. As shown in FIG. 3, the echo estimating unit 182 comprises a plurality of computing units 192, 194, . . . , 196 and an adder 198. The computing units 192, 194, . . . , 196 generate a plurality of single-tone echo estimation signals \hat{D}₀(n), . . . , \hat{D}ₖ₋₁(n) corresponding to different sub-carriers. The adder 198 generates the echo estimation signal \hat{D} by summing the single-tone echo estimation signals \hat{D}₀(n), . . . , \hat{D}ₖ₋₁(n).

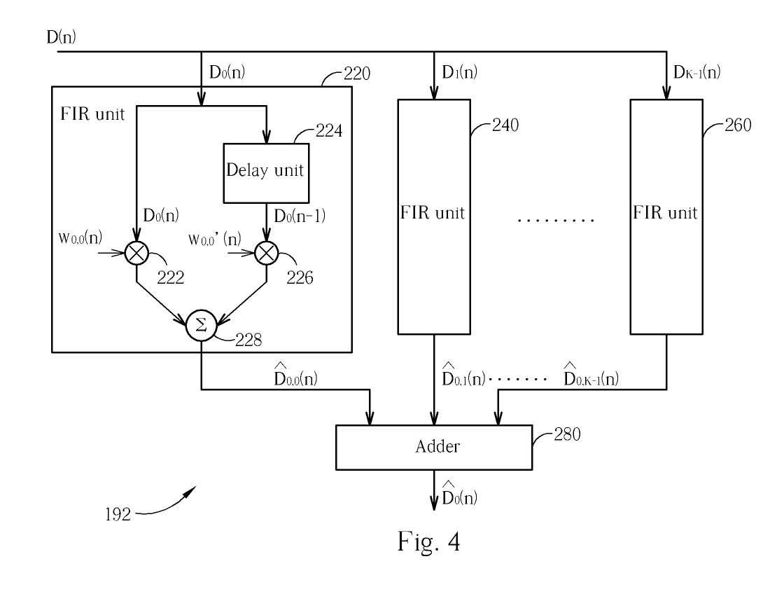

Since the architectures of the computing units 194, . . . , 196 are the same as the architecture of the computing unit 192, a further description of the computing units 194, . . . , 196 is herein omitted. Please refer to FIG. 4. FIG. 4 is a schematic diagram of the computing unit 192 shown in FIG. 3 according one embodiment of the invention. As shown in FIG. 4, the computing unit 192 is utilized to calculate a single-tone echo estimation signal \hat{D}₀. The computing unit 192 comprises a plurality of Finite Impulse Response (FIR) units 220, 240, 260, and an adder 280. Since the cause of echo may be Inter Symbol Interference (ISI), Inter carrier Interference (ICI), or a mixture of the two, the computing unit 192 accounts for the interference of each sub-carrier to the sub-data transmitted via the 0-th sub-carrier, and thereby generate the single-tone echo estimation signal \hat{D}₀. The single-tone echo estimation signal \hat{D}₀ corresponds to the interference suffered by the 0-th sub-carrier. In the present embodiment, the computing unit 192 utilizes the FIR units 220, 240, . . . , 260 to respectively adjust the sub-data \hat{D}_{0,1}(n), . . . , \hat{D}ₖ₋₁(n) according to the computing coefficients w_{0,0}, . . . , w_{0,k-1}, and thereby generates the plurality of computing values \hat{D}_{0,0}(n), . . . , D_{0,k-1}(n). The computing values \hat{D}_{0,1}(n), . . . , \hat{D}₀(n) by summing the plurality of computing values \hat{D}_{0,0}(n), . . . , \hat{D}_{0,k-1}(n), where n denotes the temporal location in the transmission sequence.

It should be noted that the FIR units 220, 240, 260 each have identical electrical architectures. Taking the FIR unit 220 as an example, the FIR unit 220 comprises a delay unit 224, a plurality of multipliers 222, 226, and an adder 228. The computing coefficients adopted by the FIR unit 220 include w_{0,0}′(n) and w_{0,0}′(n), for respectively multiplying with the sub-data D₀(n) and sub-data D₀(n−1) transmitted via the 0-th sub-carrier. Therefore, D₀(n)·W_{0,0}(n) denotes the echo of the sub-data transmitted via the 0-th sub-carrier at a current temporal point; and D₀(n−1)·w_{0,0}′(n) denotes the echo of the sub-data transmitted via the 0-th sub-carrier at a previous temporal point (i.e., ISI). The operation of generating the single-tone echo estimation signal \hat{D}₀(n) can be represented as the following equation:

$${\hat{D}}_{0} ( n ) = {\sum }_{i = 0}^{k - 1} {\hat{D}}_{0 , i} ( n ) = {\sum }_{i = 0}^{k - 1} [ {D}_{0 , i} ( n ) \cdot {w}_{0 , i} + {D}_{0 , i} ( n - 1 ) \cdot {w}_{0 , i}^{′} ] \qquad Equation ( 1 )$$

In the same manner, the computing values \hat{D}_{0,1}(n), . . . , \hat{D}_{0,k-1}(n) generated by the FIR units 240, . . . , 260 denotes the echo of other sub-carriers interfering the 0-th sub-carrier (i.e., ICI and ICSI).

It should be noted that the method of generating a single-tone echo estimation signal \hat{D}ᵢ(n) is not limited to using sub-data at two consecutive temporal points. According to different application needs, only one transmit data Dᵢ(n), as well as more than two transmit data Dᵢ(n), Dᵢ(n−1), corresponding to different temporal points, can be utilized to generate the single-tone echo estimation signal \hat{D}ᵢ(n), especially when ISI is intense. Additionally, the amount of interference between two sub-carriers decreases as the frequency difference therebetween increases. As a result, it is not necessary for the computing units 192, 194, 196 to consider the interference of every sub-carriers when calculating the single-tone echo estimation signals \hat{D}₀(n), . . . , \hat{D}ₖ₋₁(n). Therefore, it is applicable for each computing unit to generate the single-tone echo estimation signal according to less than k computing values. As one example, a computing unit needs only eleven sub-data Dᵢ₋₅(n), . . . , Dᵢ₊₅(n) to generate the single-tone echo estimation signal \hat{D}ᵢ(n). In other words, the number of the FIR units of each computing unit decreases.

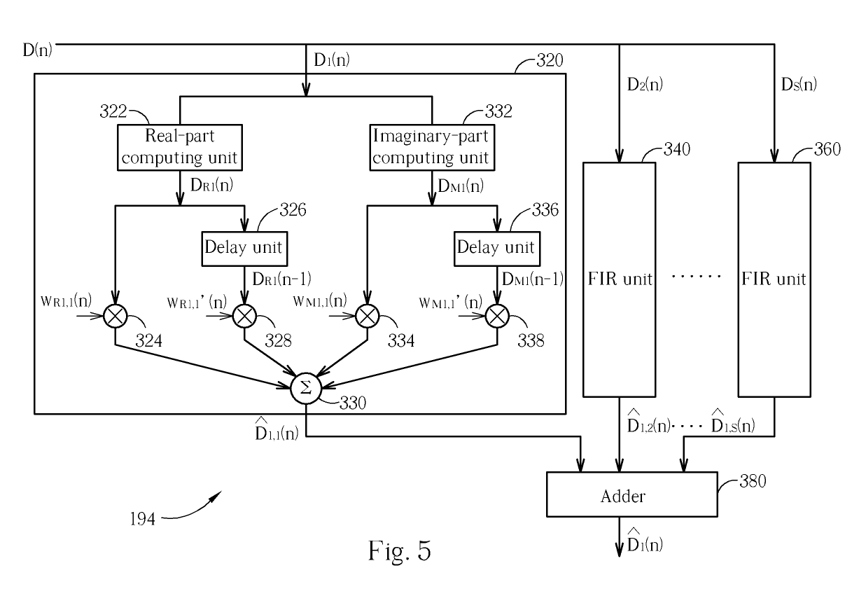

Please refer to FIG. 5. FIG. 5 is a schematic diagram of the computing unit 194 shown in FIG. 3 according to another embodiment of the invention. The second embodiment is utilized if the transmit data D has a conjugate property; that is, the sub-data Dⱼ transmitted via the j-th sub-carrier is conjugate with the sub-data Dₙ₋ⱼ transmitted via the (n−j)-th sub-carrier. Based on the conjugate property, this embodiment separates the sub-data Dⱼ into an imaginary part and a real part. Since the real part of the sub-data Dₙ₋ⱼ is the same as the real part of the sub-data Dⱼ, and the imaginary part of the sub-data Dₙ₋ⱼ is the same as the sign-inverted imaginary part of the sub-data Dₙ₋ⱼ each computing unit of the echo estimating unit has S or less than S FIR units, where S=(k/2)−1, and k denotes the number of the sub-carriers of the DMT system 100. The FIR units generate the single-tone echo estimation signals \hat{D}₁(n), . . . , \hat{D}_{S}(n) according to a plurality of computing coefficients w₁(n), . . . , w_{S}(n). It should be noted that, although only three FIR units 320, 340, 360 are shown in FIG. 5, the number of FIR units of each computing unit is not limited to the present embodiment. The adder 380 sums the computing values \hat{D}_{1,1}(n), . . . , \hat{D}_{1,S}(n) generated by the FIR units 320, 340, 360 to generate a single-tone echo estimation signal \hat{D}₁(n). Since the FIR units 320, 340, and 360 have the same architecture, the following description only takes the FIR unit 320 as an example to explain their operation. The FIR unit 320 comprises a real-part computing unit 322, an imaginary-part computing unit 332, a plurality of delay units 326, 336, a plurality of multipliers 324, 328, 334, 338, and an adder 330. The computing coefficients utilized by the FIR unit 320 comprise w_{R1,0}(n), w_{R1,0}′(n), w_{M1,0}(n), and w_{M1,0}′(n) for respectively multiplying the real part D_{R1}(n) of the sub-data D₁(n) at a current temporal point, the real part D_{R1}(n−1) ofthe sub-data D₁(n−1) at a previous temporal point, the imaginary part D_{M1}(n) of the sub-data D₁(n) at the current temporal point, and the imaginary part D_{M1}(n−1) of the sub-data D₁(n−1) at the previous temporal point. The adder 330 sums the outputs of the multipliers 324, 328, 334, 338 to generate the computing value \hat{D}_{1,1}(n). In summary, the operation of generating the single-tone echo estimation signal \hat{D}₁(n) is represented by the following equation:

$${\hat{D}}_{1} ( n ) = {\sum }_{i = 1}^{S} {\hat{D}}_{1 , i} ( n ) = {\sum }_{i = 1}^{S} [ {D}_{R1 , i} ( n ) \cdot {w}_{R1 , i} ( n ) + {D}_{R1 , i} ( n - 1 ) \cdot {w}_{R1 , i}^{′} ( n ) + {D}_{M1 , i} ( n ) \cdot {w}_{M1 , i} ( n ) + {D}_{M1 , i} ( n - 1 ) \cdot {w}_{M1 , i}^{′} ( n ) ] \qquad Equation ( 2 )$$

It should be noted that in the present invention, the method of generating the echo estimation signal \hat{D}(n) is not limited to utilizing two adjacent transmit data D(n) and D(n−1), as being made clear earlier. If the ISI in the environment is intense, the multi-carrier communication system may adopt more than two transmit data D(n), D(n−1), . . . , D(n−m) to calculate the echo estimation signal \hat{D}(n). Additionally, when the computing units 192, 194, 196 calculate the single-tone echo estimation signals \hat{D}₁(n), . . . , \hat{D}_{S}(n), it is not necessary to consider the ICI caused by all sub-carriers to reduce the number of the FIR units of each computing unit. As a result, the computation load of the computing units 192, 194, 196 decreases. Or, a computing unit may neglect the effect of some sub-carriers by setting the related computing coefficients to zero.

It should be noted that before the multi-carrier communication system 100 transmits actual data, the transmitting module 120 transmits a series of known training code sequence X as the transmit data D to determine the proper values of the computing coefficients w₀, . . . , wₖ₋₁.

As mentioned above, when the transmitting module 120 transmits a series of training code sequence X as the transmit data D, there is no signal passing through the transmitting medium except for the time domain signal x corresponding to X. As a result, a time-domain signal y received by the receiving module 140 accurately reflects the echo of the time-domain signal x, and theoretically the echo estimation signal Ŷ(n) is equal to a decoded signal Y(n) of the time-domain signal y. Based on the assumption that the echo estimation signal Ŷ(n) is equal to a decoded signal Y(n), the echo estimating unit 182 is capable of adjusting the computing coefficients w₀, . . . , wₖ₋₁ according to the LMS algorithm or any other adaptive signal processing algorithm, and thereby the echo estimation signal Ŷ(n) approaches the echo of X(n), i.e., the decoded signal Y(n). The operation of adjusting the computing coefficients w₀, . . . , wₖ₋₁ is presented as the following equations:
wᵢ(n+1)=wᵢ(n)+μeᵢ(n)·X(n) Equation (3)
eᵢ(n)=Yᵢ(n)−Ŷᵢ(n) Equation (4)

In Equations (3) and (4), i denotes the index of sub-carriers of the multi-carrier communication system 100, and n denotes the temporal point in the transmitting sequence.

As mentioned above, the multi-carrier communication system utilizes an echo estimating unit to calculate an echo estimation signal in the frequency domain according to the embodiments. Since the sampling rate of the frequency-domain signals is less than the sampling rate of the time-domain signals, the computational load of the multi-carrier communication system is reduced. Additionally, the multi-carrier communication system and the communication method thereof are capable of extracting an echo estimation signal by considering the channel responses of different sub-carriers to alleviate the ISI and ICI. As a result, the precision of the reconstructed data increases.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-carrier communication system, comprising:
a transmitting module, for executing a inversed Fourier transform upon a transmit data to generate a first time-domain signal;
a receiving module, for receiving a second time-domain signal and for executing a Fourier transform upon the second time-domain signal to generate a decoded data; and
an echo cancellation unit, coupled to the transmitting module and the receiving module, for generating a reconstructed data according to a plurality of computing coefficients, the decoded data, and the transmit data, and for adjusting the plurality of computing coefficients according to the reconstructed data.

2. The multi-carrier communication system of claim 1, wherein the echo cancellation unit adjusts the plurality of computing coefficients by executing a Least Mean Square (LMS) algorithm according to the reconstructed data.

3. The multi-carrier communication system of claim 1, wherein the echo cancellation unit adjusts the plurality of computing coefficients by executing an adaptive signal processing method according to the reconstructed data.

4. The multi-carrier communication system of claim 1, wherein the echo cancellation unit comprises:
an echo estimating unit, for generating an echo estimation signal according to the transmit data and the plurality of computing coefficients; and
an adjusting unit, coupled to the echo estimating unit, for generating the reconstructed data by adjusting the decoded data according to the echo estimation signal.

5. The multi-carrier communication system of claim 4, wherein the echo estimating unit comprises:
a plurality of computing units, each computing unit generating a single-tone echo estimation signal by adjusting the transmit data according to a plurality of computing coefficients; and
a first adder, for generating the echo estimation signal by accumulating a plurality of single-tone echo estimation signals generated by the computing units.

6. The multi-carrier communication system of claim 5, wherein the transmit data comprises a plurality of sub-data transmitted via a plurality of sub-carriers, and each computing unit comprises:
a plurality of Finite Impulse Response (FIR) units, for adjusting each sub-data according to a plurality of computing coefficients to generate a plurality of computing values, where each computing value corresponding to a specific sub-carrier; and
a second adder, for accumulating the plurality of computing values to generate a single-tone echo estimation signal.

7. The multi-carrier communication system of claim 5, wherein the transmit data comprises a plurality of sub-data transmitted via a plurality of sub-carriers, each computing coefficient comprises a real-part computing coefficient and an imaginary-part computing coefficient, and each computing unit comprises:
a plurality of FIR units corresponding to the plurality of sub-carriers, each FIR unit comprising:
an imaginary-part echo estimating unit, for generating an imaginary-part computing value by adjusting the imaginary part of a specific sub-data according to an imaginary-part computing coefficient; and
a real-part echo estimating unit, for generating a real-part computing value by adjusting the real part of the specific sub-data according to a real-part computing coefficient; and
an adder, for generating a single-tone echo estimation signal by summing a plurality of imaginary-part computing values and a plurality of real-part computing values generated by the plurality of FIR units.

8. The multi-carrier communication system of claim 7, wherein the number of the plurality of FIR units is not greater than the number of the half of the sub-carriers.

9. The multi-carrier communication system of claim 1, being a discrete multi-tone system or an Orthogonal Frequency Division Multiplexing (OFDM) system.

10. A method for eliminating echo among a multi-carrier communication system, the method comprising:
executing a inversed Fourier transform upon a transmit data to generate a first time-domain signal;
transmitting the first time-domain signal;
receiving a second time-domain signal;
generating a decoded data by executing a Fourier transform upon the second time-domain signal;
generating a reconstructed data according to a plurality of computing coefficients, the decoded data, and the transmit data; and
adjusting the plurality of computing coefficients according to the reconstructed data.

11. The method of claim 10, wherein the step of adjusting the plurality of computing coefficients comprises:
executing a Least Mean Square (LMS) algorithm according to the reconstructed data to adjust the plurality of computing coefficients.

12. The method of claim 10, wherein the step of adjusting the plurality of computing coefficients comprises:
executing an adaptive signal processing method according to the reconstructed data to adjust the plurality of computing coefficients.

13. The method of claim 10, wherein the step of generating the reconstructed data comprises:
generating an echo estimation signal according to the transmit data and the plurality of computing coefficients; and
generating the reconstructed data by adjusting the decoded data according to the echo estimation signal.

14. The method of claim 13, wherein the step of generating the echo estimation signal comprises:
generating each one of a plurality of single-tone echo estimation signals, wherein each single-tone echo estimation signal is generated by adjusting the transmit data according to a plurality of computing coefficients; and
summing the plurality of single-tone echo estimation signals to generate the echo estimation signal.

15. The method of claim 14, wherein the transmit data comprises a plurality of sub-data transmitted via a plurality of sub-carriers, and the step of generating each single-tone echo estimation signal comprises:
generating a plurality of computing values by adjusting each sub-data according to a plurality of computing coefficients, wherein each computing value corresponds to a specific sub-carrier; and
summing the plurality of computing values to generate a single-tone echo estimation signal.

16. The method of claim 14, wherein the transmit data comprises a plurality of sub-data transmitted via a plurality of sub-carriers, each computing coefficient comprises a real-part computing coefficient and an imaginary-part computing coefficient, and the step of generating each single-tone echo estimation signal comprises:
generating a plurality of imaginary-part computing values, wherein an imaginary-part computing value is generated by adjusting the imaginary part of a specific sub-data according to an imaginary-part computing coefficient;
generating a plurality of real-part computing values, wherein a real-part computing value is generated by adjusting the real part of the specific sub-data according to a real-part computing coefficient; and
summing a plurality of imaginary-part computing values and a plurality of computing values to generate a single-tone echo estimation signal.

17. The method of claim 16, wherein the specific sub-data is one of the plurality of sub-data, and the number of a plurality of specific sub-data is not greater than the number of the half of the sub-carriers.

18. The method of claim 10, wherein the multi-carrier communication system is a discrete multi-tone system or an Orthogonal Frequency Division Multiplexing (OFDM) system.

19. A multi-carrier communication apparatus for transmitting and receiving data in a multi-carrier communication system, the multi-carrier communication apparatus comprising:
a frequency-domain to time-domain converting module, for converting a first frequency-domain signal to be transmitted into a first time-domain signal;
a time-domain to frequency-domain converting module, for converting a second time-domain signal received into a second frequency-domain signal; and
an echo cancellation module, coupled to the frequency-domain to time-domain converting module and the time-domain to frequency-domain converting module, for adjusting the second frequency-domain signal according to the first frequency-domain signal thereby alleviating the echo received by the multi-carrier communication apparatus.

20. The multi-carrier communication apparatus of claim 19, the echo cancellation module further adjusts the first frequency-domain signal according to the second frequency-domain signal and a plurality of computing coefficients to generate an adjusted first frequency-domain signal.

21. The multi-carrier communication apparatus of claim 20, wherein the echo cancellation module adjusts the computing coefficients according to the adjusted first frequency-domain signal.
